(19) United States
(12) Patent Application Publication
(10) Pub. No.: US 2006/0255206 A1
(43) Pub. Date: Nov. 16, 2006

(54) Method and aircraft system for active suppression of aircraft low frequency aerostructure lateral bending modes

(76) Inventors: Mark R. Jolly, Raleigh, NC (US); Andrew D. Meyers, Apex, NC (US)

Correspondence Address: LORD CORPORATION;PATENT & LEGAL SERVICES, 111 LORD DRIVE, CARY, NC, 27512, US

(21) Appl. No.: 11/406,004

(22) Filed: Apr. 18, 2006

Related U.S. Application Data
(60) Provisional application No. 60/672,423, filed on Apr. 18, 2005.

(51) Int. Cl. B64C 13/16

(52) U.S. Cl. 244/76 R; 244/17.27

(57) ABSTRACT

An aircraft with an aircraft elastic aerostructure body inflight aerodynamically initiated transient lateral modal bending response suppression system is provided. The aircraft elastic aerostructure body has an inflight aerodynamically initiated transient lateral modal bending response which is suppressed by the transient lateral modal bending response suppression system. The aircraft transient lateral modal bending response suppression system includes a sensor for sensing the inflight aerodynamically initiated transient lateral modal bending response and an electromagnetic moving mass shaker, the electromagnetic moving mass shaker having a moving mass and a mounting base, with the moving mass shaker mounted to the elastic aerostructure body with the mounting base. The system includes a controller wherein the first sensor outputs a sensed lateral modal bending response signal into the controller and the controller electromagnetically drives the electromagnetic moving mass shaker to suppress the lateral modal bending response.

### CROSS REFERENCE

This application claims the benefit of, and incorporates by reference, U.S. Provisional Patent Application No. 60/672,423 filed on Apr. 18, 2005.

### FIELD OF THE INVENTION

The present invention relates to a method/system for controlling problematic lateral bending modes in aircraft. More particularly the invention relates to a method and system for suppressing low frequency lateral bending modes in the aerostructures of aircraft.

### BACKGROUND OF THE INVENTION

Lateral bending modes in aircraft are particularly troublesome in that they can cause fatigue and wear on the equipment, structure and occupants in the aircraft. In aircraft vehicles such as helicopters and airplanes, low frequency lateral bending modes in the aerostructures of aircraft are particularly problematic in that they can damage the actual structure and components that make up the aircraft vehicle in addition to the contents of the aircraft.

There is a need for a system and method of accurately and economically controlling problematic lateral bending modes in aircraft. There is a need for a system and method of accurately and economically suppressing low frequency lateral bending modes in the aerostructures of aircraft. There is a need for an economically feasible method of controlling lateral bending modes in the aerostructures of helicopters so that they are efficiently minimized. There is a need for an economically feasible method of controlling lateral bending modes in the aerostructures of airplanes so that they are efficiently minimized. There is a need for a robust system of suppressing low frequency lateral bending modes in the aerostructures so that the lateral bending modes are efficiently minimized. There is a need for an economic method/system for suppressing bending modes in aircraft.

### SUMMARY OF THE INVENTION

The invention includes an aircraft, the aircraft including an elastic aerostructure body having an inflight aerodynamically initiated transient lateral modal bending response. The aircraft including at least one first sensor for sensing the inflight aerodynamically initiated transient lateral modal bending response and an electromagnetic moving mass shaker, the electromagnetic moving mass shaker having a moving mass and a mounting base. Preferably the electromagnetic moving mass shaker is mounted to the elastic aerostructure body with the mounting base. The aircraft includes a controller, wherein the first sensor outputs a sensed lateral modal bending response signal into the controller and the controller electromagnetically drives the electromagnetic moving mass shaker to suppress the lateral modal bending response.

The invention includes a method of making an aircraft with suppressed inflight aerodynamically initiated transient modal bending responses. The method includes providing an aircraft with an elastic aerostructure body having an inflight aerodynamically initiated transient modal bending response, providing an aircraft elastic aerostructure body inflight aerodynamically initiated transient modal bending response suppression system, the system including an electromagnetic moving mass shaker, the electromagnetic moving mass shaker having a moving mass and a mounting base. Preferably the system includes a first sensor and a second sensor, the first sensor fixed proximate the mounting base and the second sensor fixed on the moving mass. Preferably the system includes a modal bending response controller. The method includes mounting the electromagnetic moving mass shaker to the aircraft elastic aerostructure body having the inflight aerodynamically initiated transient modal bending response wherein the first sensor and the second sensor output sensor signals into the controller and the controller drives the electromagnetic moving mass to suppress the modal bending response.

The invention includes an aircraft elastic aerostructure body inflight aerodynamically initiated transient lateral modal bending response suppression system. The system includes an electromagnetic moving mass shaker, the electromagnetic moving mass shaker having a moving mass and a mounting base, the electromagnetic moving mass shaker mounting base for mounting the electromagnetic moving mass shaker to an aircraft elastic aerostructure body having an inflight aerodynamically initiated transient lateral modal bending response. Preferably the system includes a first sensor and a second sensor, the first sensor fixed proximate the mounting base and the second sensor fixed on the moving mass. Preferably the system includes a controller, wherein the first sensor and the second sensor output sensor signals into the controller and the controller electromagnetically drives the electromagnetic moving mass at a frequency to suppress the lateral modal bending response.

The invention includes a method of making an aircraft elastic aerostructure body inflight aerodynamically initiated transient modal bending response suppression system. The method includes providing an electromagnetic moving mass shaker, the electromagnetic moving mass shaker having a moving mass and a mounting base, the electromagnetic moving mass shaker mounting base for mounting the electromagnetic moving mass shaker to an aircraft elastic aerostructure body having an inflight aerodynamically initiated transient modal bending response. The method includes providing a first sensor and providing a second sensor. The method preferably includes fixing the second sensor to the moving mass and fixing the first sensor proximate the mounting base. The method preferably includes providing a modal bending response controller and connecting the controller with the first sensor, the second sensor, and the electromagnetic moving mass shaker wherein the first sensor and the second sensor output sensor signals into the controller and the controller electromagnetically drives the electromagnetic moving mass to suppress the lateral modal bending response.

The invention includes a method of making an aircraft elastic aerostructure body inflight aerodynamically initiated transient lateral modal bending response suppression system. The method preferably includes providing a suppression system shaker, the suppression system shaker having a moving mass and a mounting base, the suppression system shaker mounting base for mounting the suppression system shaker to an aircraft elastic aerostructure body having an inflight aerodynamically initiated transient lateral modal bending response. The method preferably includes providing a first suppression system sensor and providing a second suppression system sensor for sensing the moving mass. The method preferably includes fixing the second suppression system sensor proximate the moving mass, and fixing the first suppression system sensor proximate the mounting base. The method preferably includes providing a modal bending response suppression system controller and connecting the suppression system controller with the first suppression system sensor, the second suppression system sensor, and the suppression system shaker wherein the first suppression system sensor and the second suppression system sensor output sensor signals into the suppression system controller and the suppression system controller drives the suppression system moving mass to suppress the lateral modal bending response.

It is to be understood that both the foregoing general description and the following detailed description are exemplary of the invention, and are intended to provide an overview or framework for understanding the nature and character of the invention as it is claimed. The accompanying drawings are included to provide a further understanding of the invention, and are incorporated in and constitute a part of this specification. The drawings illustrate various embodiments of the invention, and together with the description serve to explain the principals and operation of the invention.

### BRIEF DESCRIPTION OF THE DRAWINGS

FIGS. 1A-D show methods and systems for suppressing low frequency lateral bending modes in an airplane.

FIGS. 2A-D show methods and systems for suppressing low frequency lateral bending modes in a helicopter.

FIG. 3 shows a method and system for suppressing low frequency lateral bending modes.

FIGS. 4A-E show methods and systems for suppressing low frequency lateral bending modes.

FIGS. 5A-C show methods and systems for suppressing low frequency lateral bending modes.

FIG. 6 shows a plot of Base Accel/Input (g/V) (dB) y-axis and Frequency (Hz) x-axis.

FIG. 7 shows a methods and system for suppressing low frequency lateral bending modes.

FIGS. 8A-D show simulation experimental result plots.

FIGS. 9A-D show simulation experimental result plots.

FIG. 10 shows methods and systems for suppressing low frequency lateral bending modes in an aircraft.

FIG. 11 show sensor plots for a 7 Hz disturbance excitation with the system off and on.

### DETAILED DESCRIPTION OF THE PREFERRED EMBODIMENTS

Additional features and advantages of the invention will be set forth in the detailed description which follows, and in part will be readily apparent to those skilled in the art from that description or recognized by practicing the invention as described herein, including the detailed description which follows, the claims, as well as the appended drawings.

Reference will now be made in detail to the present preferred embodiments of the invention. Examples of the invention are illustrated in the accompanying drawings.

The invention includes an aircraft comprised of an elastic aerostructure body having an inflight aerodynamically initiated transient low frequency lateral modal bending response. Preferably the aircraft elastic aerostructure body inflight aerodynamically initiated transient lateral modal bending response natural frequency is less than 11 Hz, preferably with the transient lateral modal bending response natural frequency in the range from about 5 to 10 Hz. The aircraft includes at least one first sensor for sensing the inflight aerodynamically initiated transient lateral modal bending response, and preferably a second sensor. The aircraft preferably includes an electromagnetic moving mass shaker which produces an actuator force. Preferably the electromagnetic moving mass shaker is an electromagnetic sprung moving mass shaker having a moving mass and a mounting base with the electromagnetic sprung moving mass shaker mounted to the elastic aerostructure body, preferably with the electromagnetic moving mass shaker outputting a force into the aerostructure body which it is mounted to. The aircraft preferably includes a lateral modal bending response controller, wherein the first sensor outputs a sensed lateral modal bending response signal into the controller and the controller drives the electromagnetic sprung moving mass shaker to suppress the lateral modal bending response. The controller with the moving mass shaker preferably produces a lateral force that is inputted into the elastic aerostructure body to damp the inflight aerodynamically initiated transient lateral modal bending response.

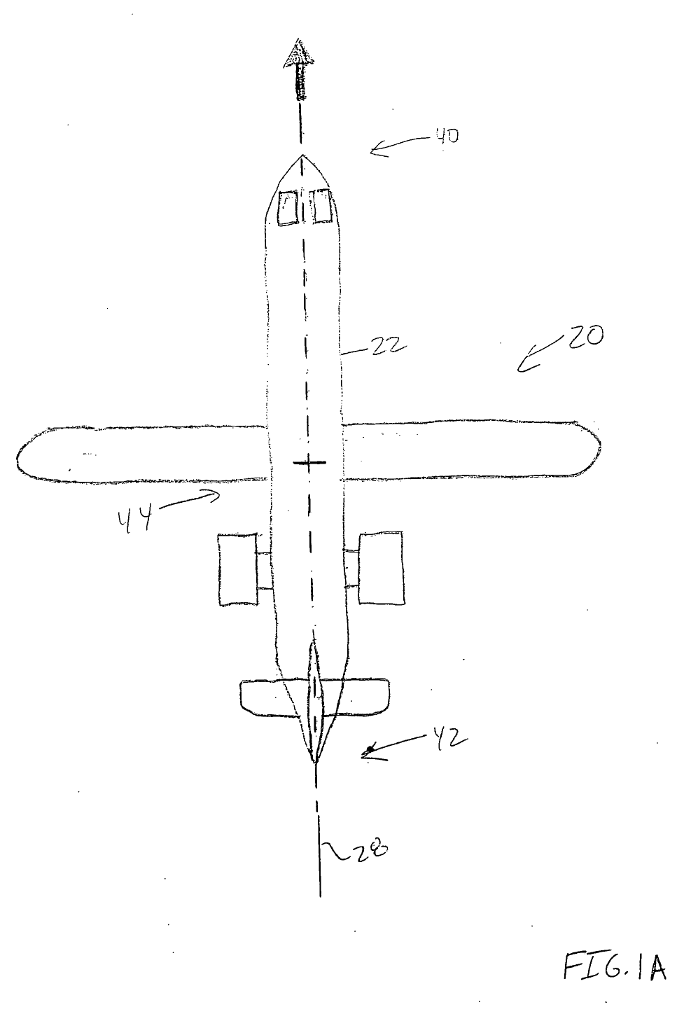

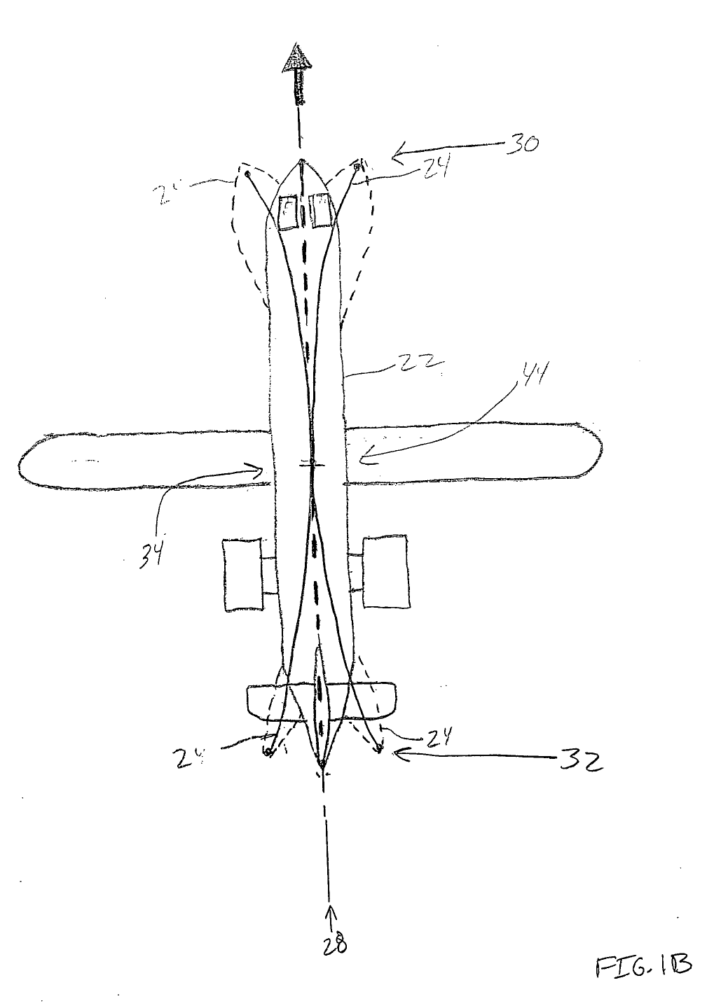

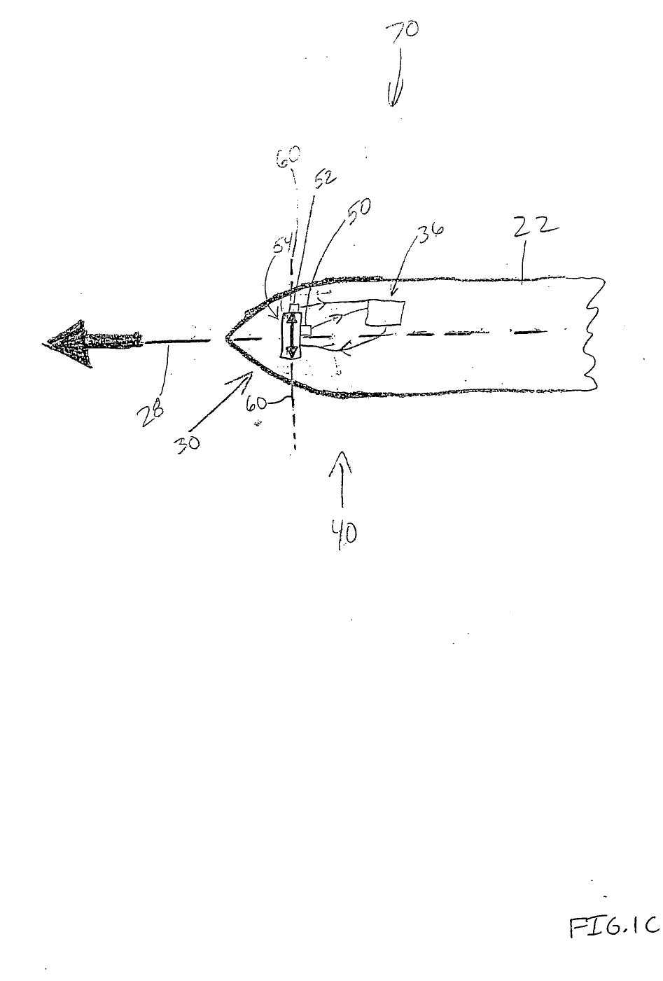

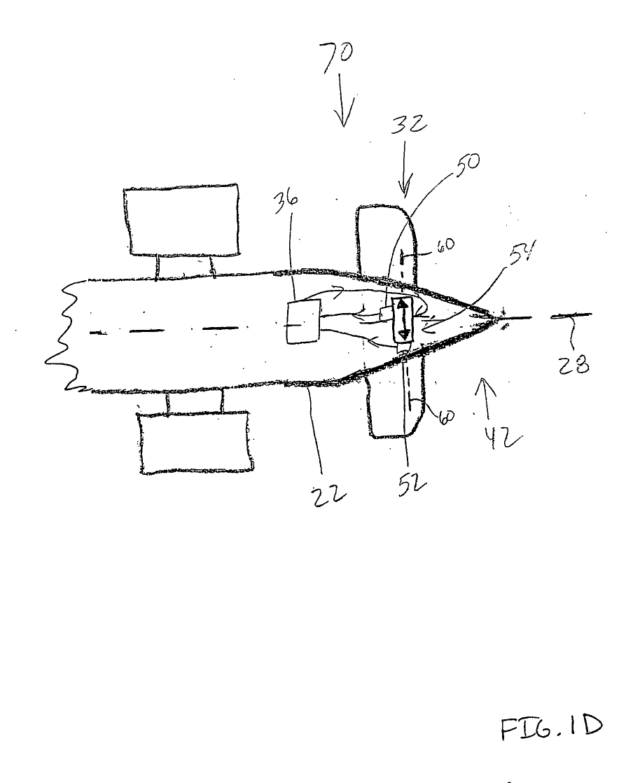

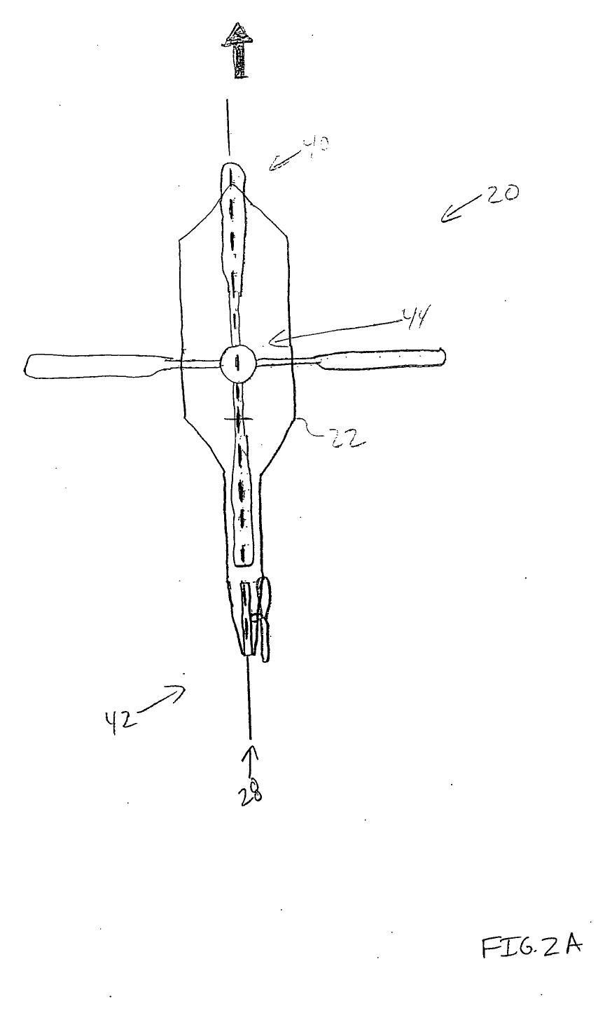

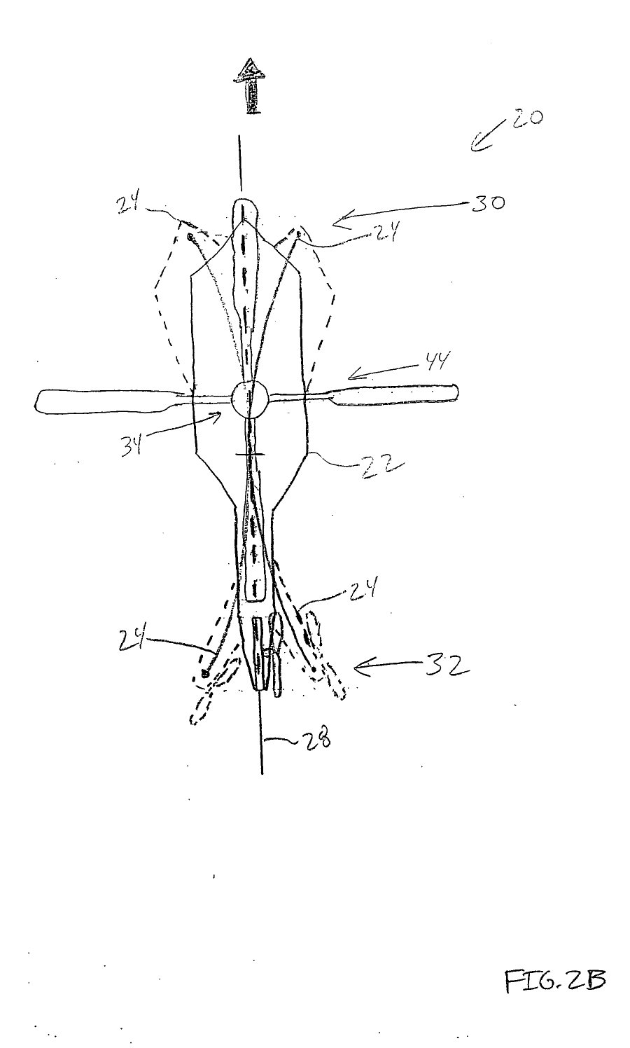

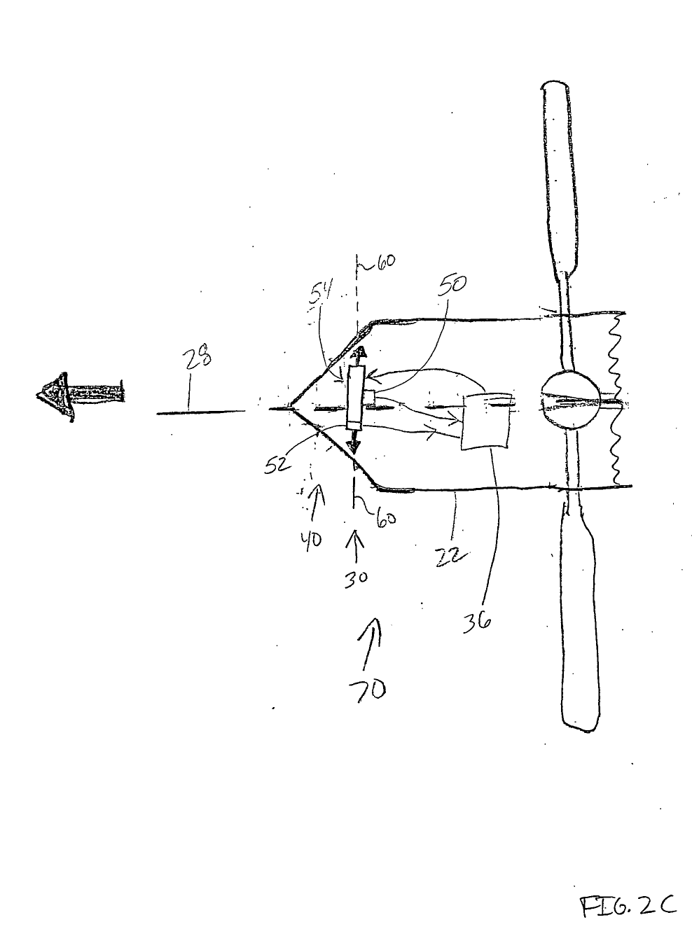

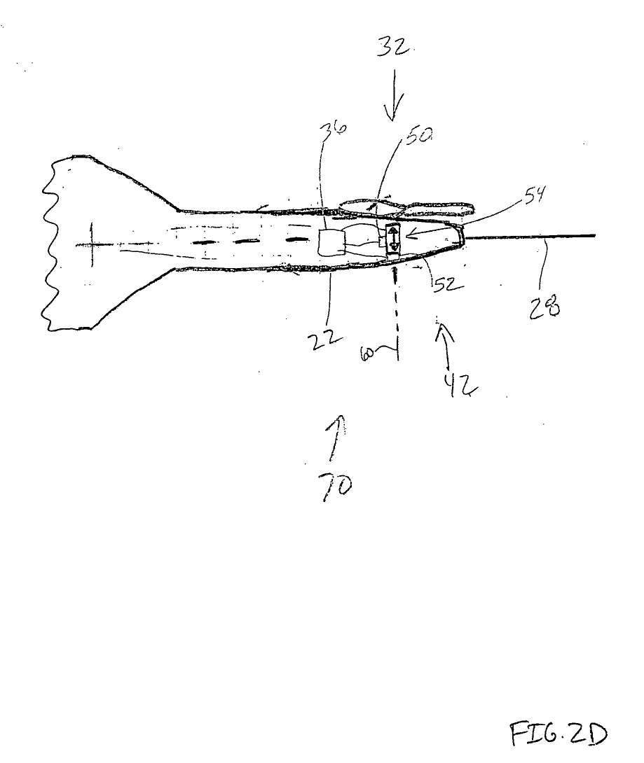

FIGS. 1-2 show aircrafts 20. The fixed wing airplane aircraft 20 of FIG. 1A is flying forward, and as shown in FIG. 1B an inflight aerodynamic air flow event causes an inflight aerodynamically initiated transient lateral modal bending response 24 in the elastic aerostructure body 22 of aircraft 20 with the longitudinal aircraft body typically bending back and fourth laterally at the nose 40 and tail 42. The rotary wing helicopter aircraft 20 of FIG. 2A is flying forward, and as shown in FIG. 2B an inflight aerodynamic air flow event causes an inflight aerodynamically initiated transient lateral modal bending response 24 in the elastic aerostructure body 22 of aircraft 20 with the flexible longitudinal aircraft body bending back and fourth laterally at the nose 40 and tail 42.

Preferably the aircraft elastic aerostructure body inflight aerodynamically initiated transient lateral modal bending response 24 has a natural frequency that is less than 11 Hz, preferably with the transient lateral modal bending response natural frequency in the range from about 5 to 10 Hz. Such aircraft elastic aerostructure body inflight aerodynamically initiated transient lateral modal bending response 24 can be initiated by an air flow interaction with the aircraft body such as a vortex or turbulent flow near the rear of the aircraft with the transient air flow interaction applying a force to the elastic aerostructure aircraft body that excites lateral modal bending response 24 characterized by bending back and fourth laterally at the nose 40 and tail 42. The aircraft includes at least one first sensor 50 for sensing the inflight aerodynamically initiated transient lateral modal bending response 24, and preferably a second sensor 52. The aircraft includes an electromagnetic moving mass shaker 54, the electromagnetic moving mass shaker having a moving mass 56 and a mounting base 58 with the electromagnetic moving mass shaker mounted to the elastic aerostructure body 22, preferably with the electromagnetic moving mass shaker comprising a sprung moving mass shaker. The aircraft includes a lateral modal bending response controller 36 wherein the first sensor 50 outputs a sensed lateral modal bending response signal into the controller and the controller 36 actively electromagnetically drives the electromagnetic sprung moving mass shaker 54 to suppress the lateral modal bending response 24. The controller with the moving mass shaker produce a lateral force that is inputted into the elastic aerostructure body to damp the inflight aerodynamically initiated transient lateral modal bending response. Preferably the controller 36 and shaker 54 output an inertial force into the body 22, preferably an oscillating inertial force.

As shown in FIGS. 1B and 2B the inflight aerodynamically initiated transient lateral modal bending response 24 is the first mode, as compared with higher order modes such as a second or third mode shape. Preferably the electromagnetically driven sprung moving mass longitudinal shaker 54 has a primary vibration force axis 60, with the shaker 54 mounted to align with and suppress the lateral mode 24, preferably with the linear inertial longitudinal shaker force axis 60 normal to the longitudinal axis 28 of the aircraft. Preferably the linear inertial longitudinal shaker 54 force axis 60 is oriented and mounted perpendicular to the forward traveling direction of the aircraft 22. Preferably the controller 36 includes a computer processor and a power amplifier, with the sensor signal inputs processed to generate an amplifier output signal drive current to actively drive the electromagnetic sprung moving mass shaker 54 in the primary vibration axis 60 at an appropriate force to damp the modal bending response 24, preferably as a force follower with the moving mass 56 sensed force produced to minimize the lateral mode force sensed by the base mount accelerometer sensor 50.

Preferably the elastic aerostructure body 22 has a front nose 40, a rear tail 42, and a midsection 44 between the front nose 40 and the rear tail 42 with the inflight aerodynamically initiated transient lateral modal bending response 24 having a front antinode 30, the front antinode 30 proximate the front nose 40. Preferably the elastic aerostructure body 22 inflight aerodynamically initiated transient lateral modal bending response 24 has a rear antinode 32, the rear antinode 32 proximate the rear tail 42, and a middle node 34 in the body midsection 44 between the front nose 40 and the rear tail 42. Preferably the electromagnetic sprung moving mass shaker 54 has a natural resonant frequency with the electromagnetic sprung moving mass shaker natural resonant frequency less than 15 Hz. Preferably the electromagnetic sprung moving mass shaker 54 has a natural resonant frequency with the electromagnetic sprung moving mass shaker natural resonant frequency is proximal the natural frequency of the transient lateral modal bending response 24. Preferably the electromagnetic sprung moving mass shaker natural resonant frequency is at or below the transient lateral modal bending response 24 natural frequency. Preferably the electromagnetic sprung moving mass shaker natural resonant frequency is no greater than 10% of the transient lateral modal bending response 24 natural frequency. Preferably the moving mass 56 and springs 62 of the electromagnetically driven sprung moving mass shaker 54 are selected to provide the natural frequency fn less than the lateral modal disturbance frequency fd, preferably with fn proximate fd. In an embodiment such as shown in FIG. 1 the aircraft 20 is a fixed wing aircraft with wings fixed to the aircraft body. In an embodiment such as shown in FIG. 2 the aircraft 20 is a rotary wing helicopter aircraft with a plurality of rotating rotary wings. Preferably the electromagnetic sprung moving mass shaker 54 is a linear longitudinal actuator with the moving mass 56 driven electromagnetically back and forth to produce and output the oscillating inertial force. In an embodiment such as shown in FIG. 3, the linear moving mass shaker 54 is preferably a linear voice-coil actuator electromagnetic moving mass shaker. In an embodiment such as shown in FIG. 4, the linear moving mass shaker 54 is a multiple phase linear motor, preferably a multiple (three) phase tubular linear motor actuator with an inner permanent magnet rod motor shaft armature including alternating magnetic poles translated along multiple phase encompassing tubular electromagnetic coils of the tubular motor body of the electromagnetic moving mass shaker. Preferably a first sensor 50 and a second sensor 52 are connected with the shaker 54 and the controller 36 to provide the transient lateral modal bending response suppression force. Preferably the sensors 50 and 52 are accelerometers. Preferably the first accelerometer sensor 50 is proximate and fixed at the mounting base 58 of the shaker 54. Preferably the second accelerometer sensor 52 is fixed on the moving mass 56 of the shaker 54. Preferably the accelerometer 52 on the moving mass inferring the inertial force generated by the shaker and the other accelerometer 50 measuring mounting base motion of the lateral modal bending response motion of the aerostructure body at the mounting point of the shaker. Preferably the mounting base is located and mounted to the aircraft body 22 proximate at least one of the two antinodes 30,32.

Preferably the invention includes a method of making an aircraft 20 with suppressed inflight aerodynamically initiated transient lateral modal bending responses. The method includes providing an aircraft 20 comprised of an elastic aerostructure body 22 having a inflight aerodynamically initiated transient lateral modal bending response 24, preferably with a modal bending response natural frequency in the range from about 5 to 10 Hz. The method includes providing an aircraft elastic aerostructure body inflight aerodynamically initiated transient lateral modal bending response suppression system 70. The aircraft elastic aerostructure body inflight aerodynamically initiated transient modal bending response suppression system 70 comprised of an electromagnetic driven sprung moving mass shaker 54, with the electromagnetic moving mass shaker having a linear moving mass 56 and a mounting base 58, a first sensor 50 and a second sensor 52, with the first sensor 50 fixed proximate the mounting base 58 and the second sensor 52 fixed on the moving mass 56, and a controller 36. The method includes orienting and mounting the electromagnetic moving mass shaker 54 to the aircraft elastic aerostructure body 22 having the inflight aerodynamically initiated transient modal bending response 24 wherein the first sensor 50 and the second sensor 52 output sensor signals into the modal bending response controller 36 and the modal bending response controller electromagnetically drives the electromagnetic moving mass 56 to suppress the lateral modal bending response 24. Preferably the elastic aerostructure body 22 has an antinodal front nose 40, an antinodal rear tail 42, and a nodal midsection 44 between the nose 40 and the rear tail 42, with the inflight aerodynamically initiated transient lateral modal bending response 24 having a first antinode 30 proximate the front nose and a second antinode 32 proximate the rear tail, and an electromagnetic moving mass shaker 54 is mounted proximate at least one of the antinodes 30, 32.

Preferably the electromagnetic sprung moving mass shaker 54 has a natural resonant frequency with the electromagnetic sprung moving mass shaker natural resonant frequency less than 15 Hz. Preferably the electromagnetic sprung moving mass shaker 54 has a natural resonant frequency with the electromagnetic sprung moving mass shaker natural resonant frequency proximal the natural frequency of the transient lateral modal bending response 24. Preferably the electromagnetic sprung moving mass shaker natural resonant frequency is at or below the transient lateral modal bending response 24 natural frequency. Preferably the electromagnetic sprung moving mass shaker natural resonant frequency is no greater than 10% of the transient lateral modal bending response 24 natural frequency. Preferably the moving mass 56 and springs 62 of the electromagnetically driven sprung moving mass shaker 54 are selected to provide the natural frequency fn less than the lateral modal disturbance frequency fd, preferably with fn proximate fd. In an embodiment such as shown in FIG. 1 the aircraft 20 is a fixed wing aircraft with wings fixed to the aircraft body. In an embodiment such as shown in FIG. 2 the aircraft 20 is a rotary wing helicopter aircraft with a plurality of rotating rotary wings. Preferably the electromagnetic sprung moving mass shaker 54 is a longitudinal linear actuator with the moving mass 56 driven electromagnetically back and forth to produce and output the oscillating inertial force. In an embodiment such as shown in FIG. 3, the linear moving mass shaker 54 is preferably a linear voice-coil actuator electromagnetic moving mass shaker. In an embodiment such as shown in FIG. 4, the linear moving mass shaker 54 is preferably a multiple (three) phase tubular linear motor actuator with a permanent magnet rod motor shaft armature including alternating magnetic poles translated along multiple phase encompassing tubular electromagnetic coils of the tubular motor body of the electromagnetic moving mass shaker. Preferably a first sensor 50 and a second sensor 52 are connected with the shaker 54 and the controller 36 to provide the transient lateral modal bending response suppression force. Preferably the sensors 50 and 52 are accelerometers. Preferably the first accelerometer sensor 50 is proximate and fixed at the mounting base 58 of the shaker 54. Preferably the second accelerometer sensor 52 is fixed on the moving mass 56 of the shaker 54. Preferably the accelerometer 52 on the moving mass inferring the inertial force generated by the shaker and the other accelerometer 50 measuring mounting base motion of the lateral modal bending response motion of the aerostructure body at the mounting point of the shaker. Preferably the mounting base is located and mounted to the aircraft body 22 proximate at least one of the two antinodes 30,32. Preferably the electromagnetically driven sprung moving mass shaker 54 has a primary vibration force axis 60, with the shaker 54 mounted to align with and suppress the lateral mode 24, preferably with the linear inertial longitudinal shaker force axis 60 normal to the longitudinal axis 28 of the aircraft. Preferably the linear inertial longitudinal shaker 54 force axis 60 is oriented and mounted perpendicular to the forward traveling direction of the aircraft 22. Preferably the controller 36 includes a computer processor and a power amplifier, with the sensor signal inputs processed to generate an amplifier output signal drive current to actively drive the electromagnetic sprung moving mass shaker 54 in the primary vibration axis 60 at an appropriate force to suppress the modal bending response 24, preferably as a force follower with the moving mass 56 sensed force produced to minimize the lateral mode force sensed by the base mount accelerometer sensor 50.

Preferably the invention includes the aircraft elastic aerostructure body inflight aerodynamically initiated transient lateral modal bending response suppression system 70. The transient modal bending response suppression system 70 is comprised of the electromagnetic sprung moving mass shaker 54, with the electromagnetic driven moving mass shaker having a moving mass 56 and a mounting base 58, the electromagnetic moving mass shaker mounting base 58 for mounting the electromagnetic moving mass shaker 54 to an aircraft elastic aerostructure body 22 having an inflight aerodynamically initiated transient lateral modal bending response 24. The transient modal bending response suppression system 70 includes the first sensor 50 and the second sensor 52, with the first sensor fixed proximate the mounting base 58 and the second sensor fixed on the moving mass 56. The transient modal bending response suppression system 70 includes the lateral modal bending response controller 36 with the first sensor 50 and the second sensor 52 outputting sensor signals into the controller 36 and the controller electromagnetically driving the sprung electromagnetic moving mass 56 in a manner so as to suppress the lateral modal bending response 24. Preferably the electromagnetic sprung moving mass shaker 54 has a natural resonant frequency with the electromagnetic sprung moving mass shaker natural resonant frequency less than 15 Hz. Preferably the electromagnetic sprung moving mass shaker 54 has a natural resonant frequency with the electromagnetic sprung moving mass shaker natural resonant frequency proximal the natural frequency of the transient lateral modal bending response 24. Preferably the electromagnetic sprung moving mass shaker natural resonant frequency is at or below the transient lateral modal bending response 24 natural frequency. Preferably the electromagnetic sprung moving mass shaker natural resonant frequency is no greater than 10% of the transient lateral modal bending response 24 natural frequency. Preferably the moving mass 56 and springs 62 of the electromagnetically driven sprung moving mass shaker 54 are selected to provide the natural frequency fn less than the lateral modal disturbance frequency fd, preferably with fn proximate fd. Preferably the electromagnetic sprung moving mass shaker 54 is a linear actuator with the moving mass 56 driven electromagnetically back and forth to produce and output the oscillating inertial force. In an embodiment such as shown in FIG. 3, the linear moving mass shaker 54 is preferably a linear voice-coil actuator electromagnetic moving mass shaker. In an embodiment such as shown in FIG. 4, the linear moving mass shaker 54 is preferably a multiple (three) phase tubular linear motor actuator with a multiple alternating inner permanent magnet rod motor shaft armature translated along multiple phase encompassing tubular electromagnetic coils of the tubular motor body of the electromagnetic moving mass shaker. Preferably the first sensor 50 and the second sensor 52 are connected with the shaker 54 and the controller 36 to provide the transient lateral modal bending response suppressing force. Preferably the sensors 50 and 52 are accelerometers. Preferably the first accelerometer sensor 50 is fixed proximate the mounting base 58. Preferably the second accelerometer sensor 52 is fixed on the moving mass 56. Preferably the accelerometer 52 on the moving mass infers the inertial force generated by the shaker and the other accelerometer 50 measures the mounting base motion of the lateral modal bending response motion of the aerostructure body at the mounting point of the shaker. Preferably the mounting base is adapted for orientation and mounting to the aircraft body 22 proximate at least one of the two antinodes 30,32. Preferably the electromagnetically driven sprung moving mass shaker 54 has a primary vibration force axis 60, with the shaker 54 adapted for orientation and mounting to align with and suppress the lateral mode 24, preferably with the linear inertial longitudinal shaker force axis 60 normal to the longitudinal axis 28 of the aircraft. Preferably the linear inertial longitudinal shaker 54 force axis 60 is oriented and mounted perpendicular to the forward traveling direction of the aircraft 22. Preferably the controller 36 includes a computer processor and a power amplifier, with the sensor signal inputs processed to generate an amplifier output signal drive current to actively drive the electromagnetic moving mass shaker 54 in the primary vibration axis 60 at an appropriate force to suppress the modal bending response 24, preferably as a force follower with the moving mass 56 sensed force produced to minimize the lateral mode force sensed by the base mount accelerometer sensor 50.

Preferably the invention includes the method of making the aircraft elastic aerostructure body inflight aerodynamically initiated transient lateral modal bending response suppression system 70. The method including providing the electromagnetic sprung moving mass shaker 54, the electromagnetic moving mass shaker 54 having the moving mass 56 and the mounting base 58 for mounting the electromagnetic moving mass shaker 54 to an aircraft elastic aerostructure body 22 having an inflight aerodynamically initiated transient lateral modal bending response 24. The method includes providing the first sensor 50 and the second sensor 52. The method includes fixing the second sensor 52 to the moving mass 56 and fixing the first sensor 50 proximate the mounting base 58. The method includes providing the controller 36 and connecting the controller 36 with the first sensor 50, the second sensor 52, and the electromagnetic moving mass shaker 54 wherein the first sensor and the second sensor output sensor signals into the modal bending response controller 36 and the controller electromagnetically drives the electromagnetic moving mass 56 to suppress the lateral modal bending response 24. Preferably the electromagnetic sprung moving mass shaker 54 has a natural resonant frequency with the controller driving the shaker proximate its natural frequency. Preferably the electromagnetic sprung moving mass shaker natural resonant frequency is less than 15 Hz. Preferably the electromagnetic sprung moving mass shaker 54 natural resonant frequency is proximal the natural frequency of the transient lateral modal bending response 24. Preferably the electromagnetic sprung moving mass shaker natural resonant frequency is at or below the transient lateral modal bending response 24 natural frequency. Preferably the electromagnetic sprung moving mass shaker natural resonant frequency is no greater than 10% of the transient lateral modal bending response 24 natural frequency. Preferably the moving mass 56 and springs 62 of the electromagnetically driven sprung moving mass shaker 54 are selected to provide the natural frequency fn less than the lateral modal disturbance frequency fd, preferably with fn proximate fd. Preferably the electromagnetic sprung moving mass shaker 54 is a linear actuator with the moving mass 56 driven electromagnetically back and forth to produce and output the oscillating inertial force. In an embodiment such as shown in FIG. 3, the linear moving mass shaker 54 is preferably a linear voice-coil actuator electromagnetic moving mass shaker. In an embodiment such as shown in FIG. 4, the linear moving mass shaker 54 is preferably a multiple (three) phase tubular linear motor actuator with a permanent magnet rod motor shaft armature including alternating magnetic poles translated along multiple phase encompassing tubular electromagnetic coils of the tubular motor body of the electromagnetic moving mass shaker. Preferably the first sensor 50 and the second sensor 52 are connected with the shaker 54 and the controller 36 to provide the transient lateral modal bending response suppressing force. Preferably the sensors 50 and 52 are accelerometers. Preferably the first accelerometer sensor 50 is fixed proximate the mounting base 58. Preferably the second accelerometer sensor 52 is fixed on the moving mass 56. Preferably the accelerometer 52 on the moving mass infers the inertial force generated by the shaker and the other accelerometer 50 measures the mounting base motion of the lateral modal bending response motion of the aerostructure body at the mounting point of the shaker. Preferably the mounting base is adapted for orientation and mounting to the aircraft body 22 proximate at least one of the two antinodes 30,32. Preferably the electromagnetically driven sprung moving mass shaker 54 has a primary vibration force axis 60, with the shaker 54 adapted for orientation and mounting to align with and suppress the lateral mode 24, preferably with the linear inertial longitudinal shaker force axis 60 normal to the longitudinal axis 28 of the aircraft. Preferably the linear inertial longitudinal shaker 54 force axis 60 is oriented and mounted perpendicular to the forward traveling direction of the aircraft 22. Preferably the controller 36 includes a computer processor and a power amplifier, with the sensor signal inputs processed to generate an amplifier output signal drive current to actively drive the electromagnetic moving mass shaker 54 in the primary vibration axis 60 at an appropriate force to suppress the modal bending response 24, preferably as a force follower with the moving mass 56 sensed force produced to minimize the lateral mode motion sensed by the base mount accelerometer sensor 50.

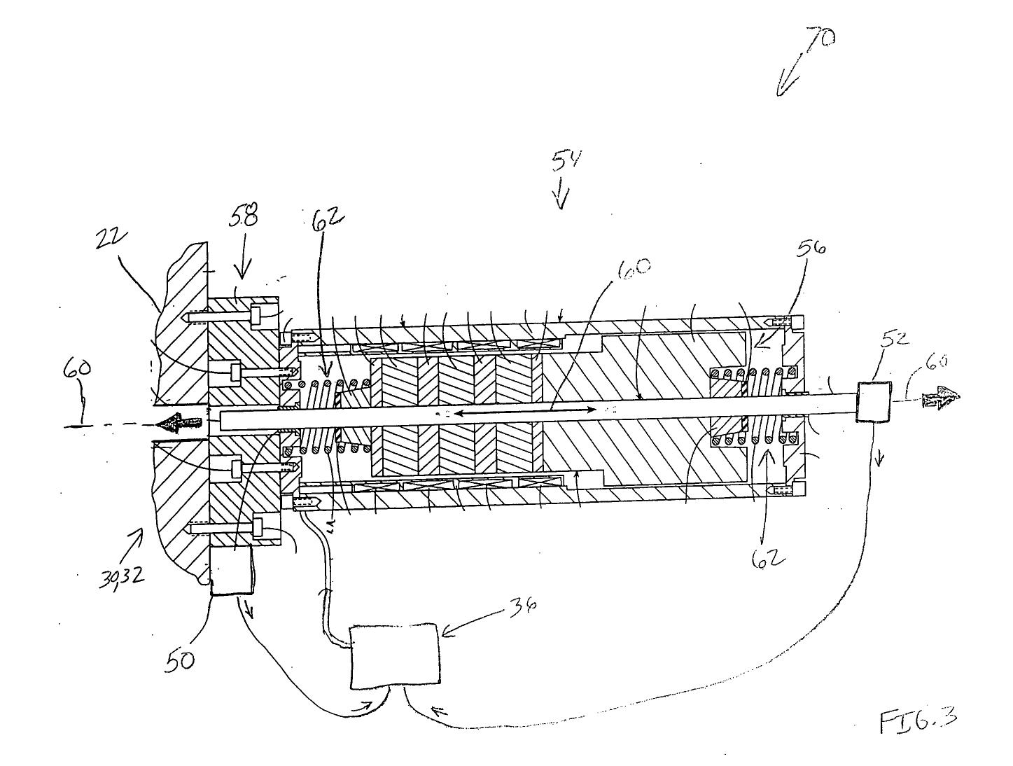

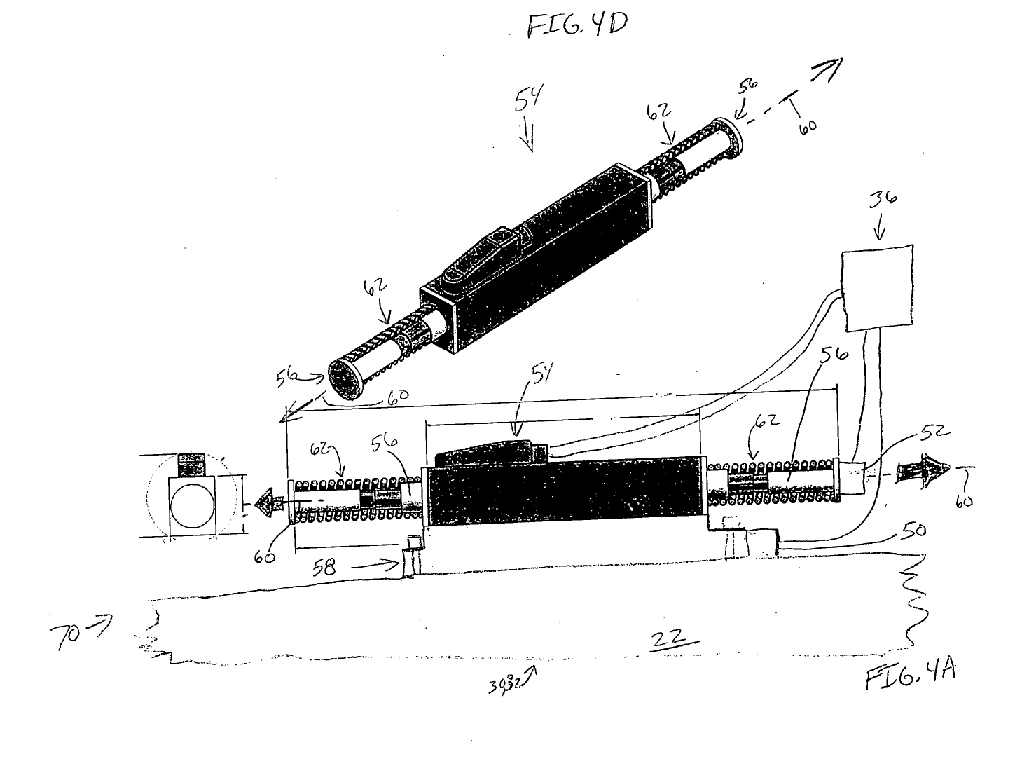

As shown in FIG. 5, the transient inflight aerodynamic disturbance d enters into the aircraft 20 and produces the inflight aerodynamically initiated transient lateral modal bending response in the aircraft elastic aerostructure body 22 that is sensed and measured as an acceleration a by the first sensor 50 of the suppression system 70 which outputs force F from the shaker 54 into the aircraft body 22 to minimize the acceleration of the body as sensed by the first sensor 50. FIG. 5B shows the inner and outer loop of the aircraft elastic aerostructure body inflight aerodynamically initiated transient lateral modal bending response suppression system, with the inner loop separately shown in FIG. 5C. The second sensor 52 mounted on the moving mass 56 of shaker 54 measures the acceleration of the moving mass, with the force F outputted by the shaker proportional to that acceleration [F=(mass of 56)(acceleration of 56)]. With the controller 36 controlling the shaker 54 with the inner loop, the system is able to output a force F proportional to a variable input r, thus utilizing the moving mass shaker 54 a proportional force generator inside a bandwidth interval. The outer control loop of the suppression system 70 utilizes the proportional force generator to create force F in the aircraft body 22 to control the aircraft modal bending response 24. With the electromagnetically driven sprung moving mass shaker 54 converted into a command force output generator by the controller and accelerometer sensor, the system outputs the lateral force F to suppress the inflight aerodynamically initiated transient lateral modal bending response 24. The suppression system 70 actively controls the electromagnetically driven sprung moving mass shaker 54 to actively suppress the low frequency aerostructure mode responses of the aircraft body 22. The moving mass inertial actuator shakers 54 are utilized to incorporate finite bandwidth inertial damping of the aircraft, and actively attenuate the low frequency modal response of the aerostructure body 22.

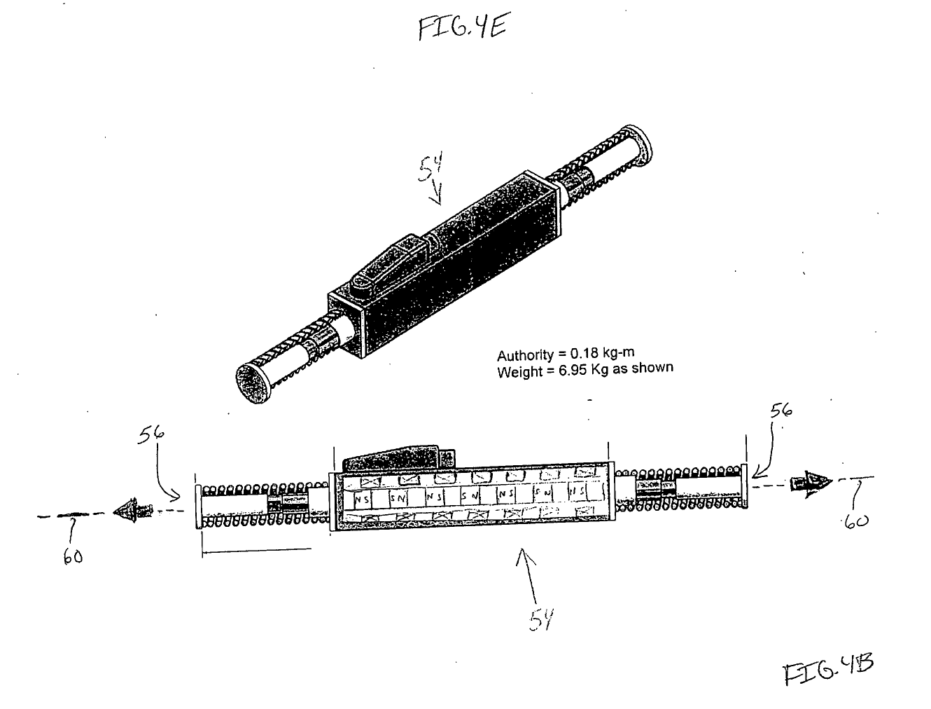

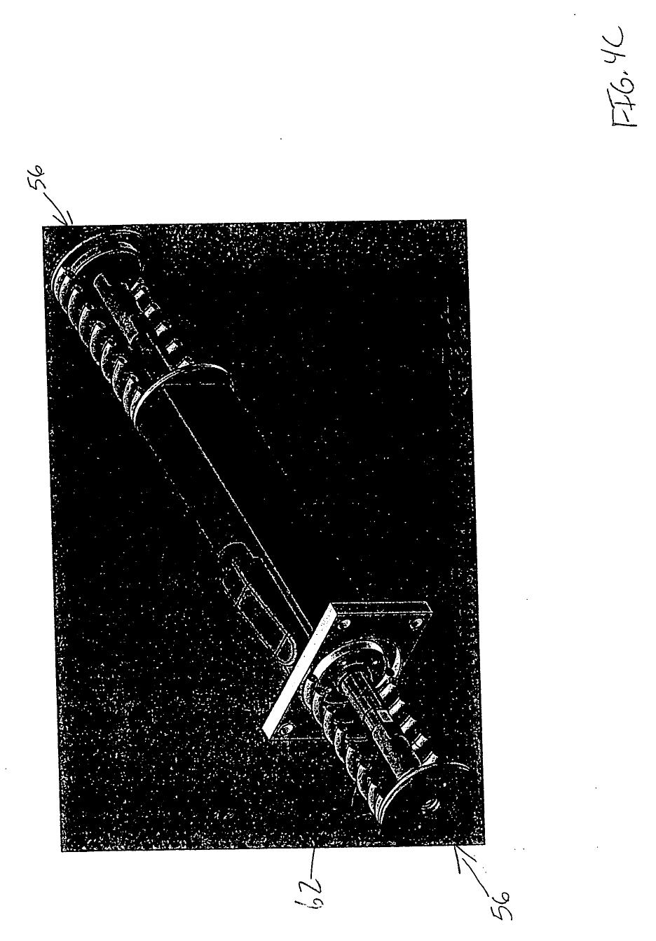

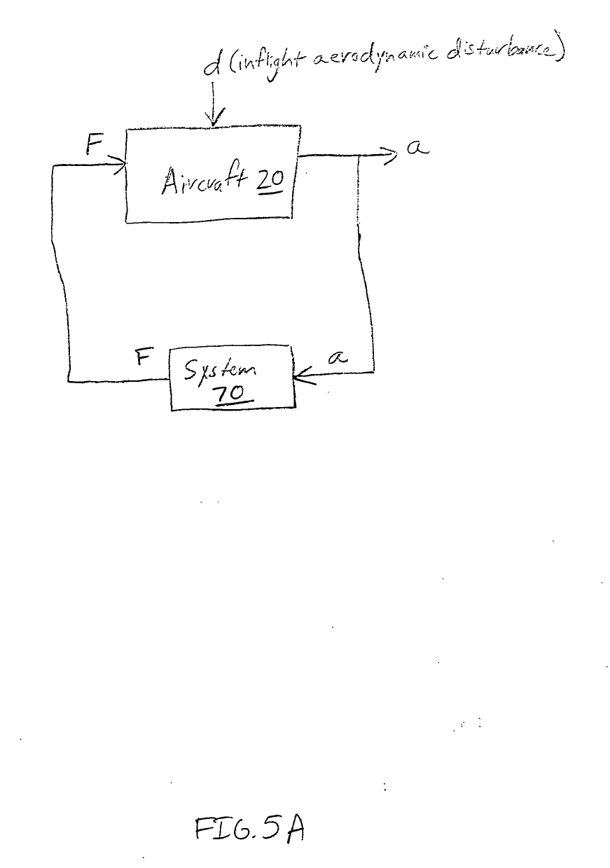

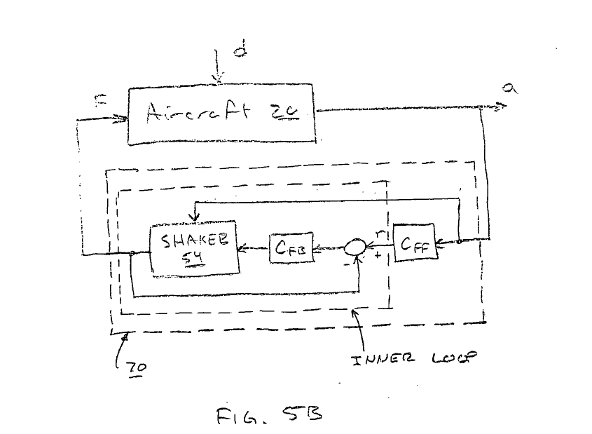

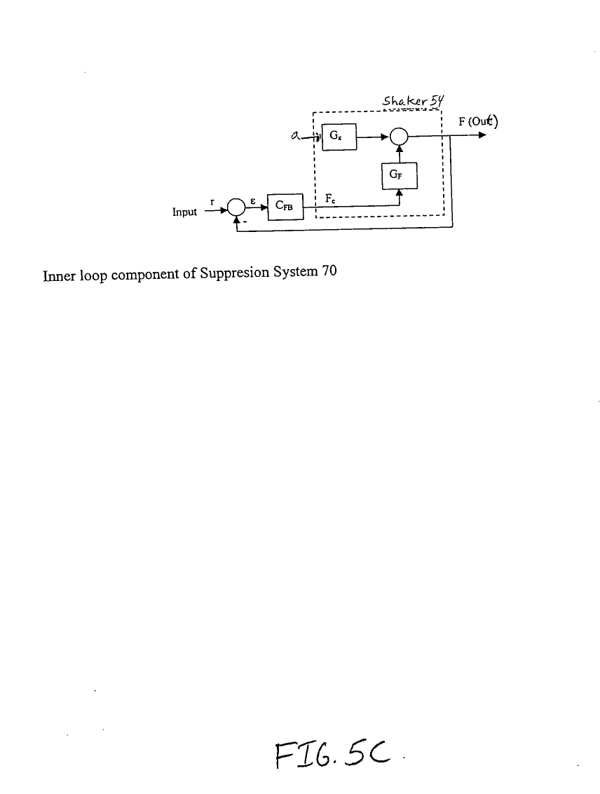

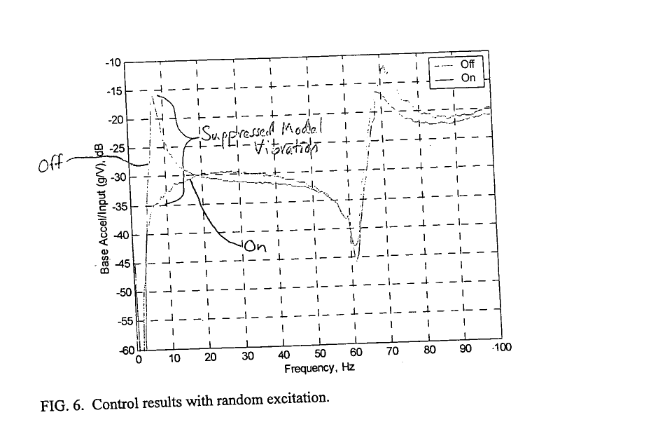

As an example of active attenuation of the low frequency modal response in aerostructures, FIG. 1B shows an illustration of an airplane 20 exhibiting an about 9 Hz lateral modal response where the nose, midsection and tail approximately correspond to antinode, node and antinode, respectively, with this mode excited by a transient aerodynamic instability, such as an aerodynamic instability in the region of the tail 42. The Off (blue) line frequency response in FIG. 6 shows such a lateral modal response of an elastic body with a modal response peak at about 9 Hz. The Off (blue) line frequency response in FIG. 6 is the uncontrolled response of an aerostructure body 22 with the suppression system 70 turned off. The suppression control system 70 includes the electromagnetically driven sprung moving mass shaker 54 and the collocated vibration sensor accelerometers 50, 52, with the moving mass shaker 54 driven in order to implement a control that approximates inertial damping over a finite frequency range.

Preferably the system utilizes two control accelerometers: one (second sensor 52) on the moving mass 56 measuring force output from the shaker F, and one (first sensor 50) on the mounting base 58 measuring input motion. FIG. 7 shows the basic block diagram with blocks G_{f} and Gₓ representing transfer functions associated with the inertial moving mass shaker and blocks C_{FF} and C_{FB} representing feedback compensators. This structure is conducive to sequential loop closure where C_{FB} is the inner loop and C_{FF} is the outer loop.

With the structure in FIG. 7,

$$\frac{F}{a} = \frac{{G}_{x} + {G}_{F} {C}_{FB} {C}_{FF}}{1 + {G}_{F} {C}_{FB}}$$

where G_{X} and G_{F} describe the inertial linear actuator moving mass shaker and C_{FF} and C_{FB} are to be designed. Note that if
G_{F}C_{FB}>>1 and G_{F}C_{FB}>>G_{X}
then,
F˜C_{FF}a
Loop shaping suggests the form C_{FB}=K/s where K is large.
Now, by making C_{FF} look like C_{FF}=−bₒ/s in the frequency range of interest (preferably range of about 1 to 60 Hz), inertial damping is achieved.
For the inner loop shown in FIG. 5C, the following forms of compensators were explored.

$$\begin{matrix}{C}_{FB , a} = \frac{K}{s} & ( a ) \\ {C}_{FB , b} = \frac{Ks}{{s}^{2} + 2 {ω}_{b} s + {ω}_{b}^{2}} , & ( b ) \\ {C}_{FB , c} = \frac{K ( s + {w}_{1} )}{{s}^{2} + 3 {ω}_{b} s + {ω}_{b}^{2}} , K = 300 , {ω}_{b} = 1.5 Hz , {ω}_{1} = 2.1 Hz & ( c )\end{matrix}$$

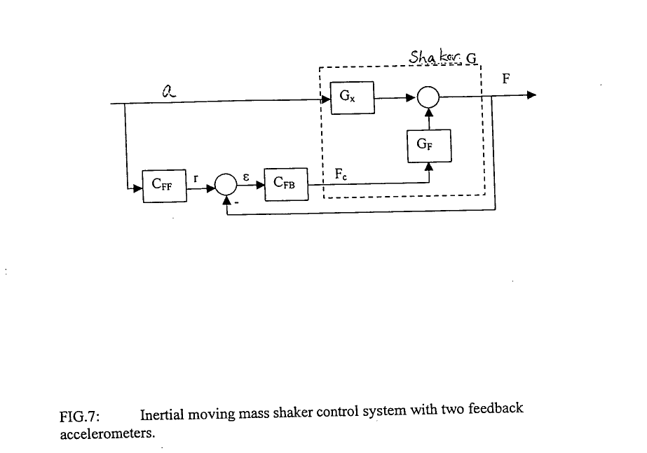

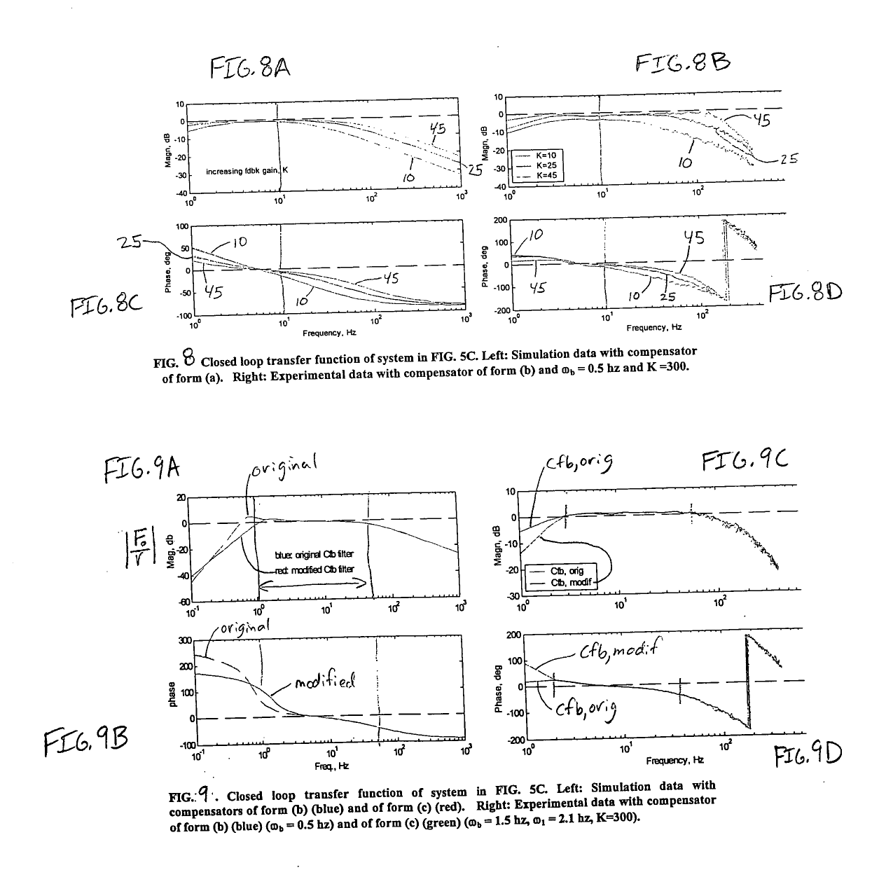

The goal of forms (b) and (c) were to emulate (a) and to minimize “drifting” of the inertial linear moving mass actuator armature. Form (c) was found to accomplish this the best. The inner loop turns the inertial linear moving mass actuator into a command force follower. The following plots of simulation and experimental data illustrate this. The frequency range in which the closed loop bode plot is near 0 db and 0 phase represents the regions where the inertial linear moving mass actuator is behaving as a force command follower. These regions are designed to be in the vicinity of 9 Hz. FIG. 8. shows the closed loop transfer function of the system in FIG. 5C. On the left of FIG. 8 is the simulation data with compensator of form (a). On the right of FIG. 8 is the experimental data with compensator of form (b) and ω_{b}=0.5 Hz and K=300. FIG. 9 shows the closed loop transfer function of the system in FIG. 5C. On the left of FIG. 9 is the simulation data with compensators of form (b) (blue) and of form (c) (red). On the right of FIG. 9 is the experimental data with compensator of form (b) (blue) (ω_{b}=0.5 hz) and of form (c) (green) (ω_{b}=1.5 hz, ω₁=2.1 hz, K=300).

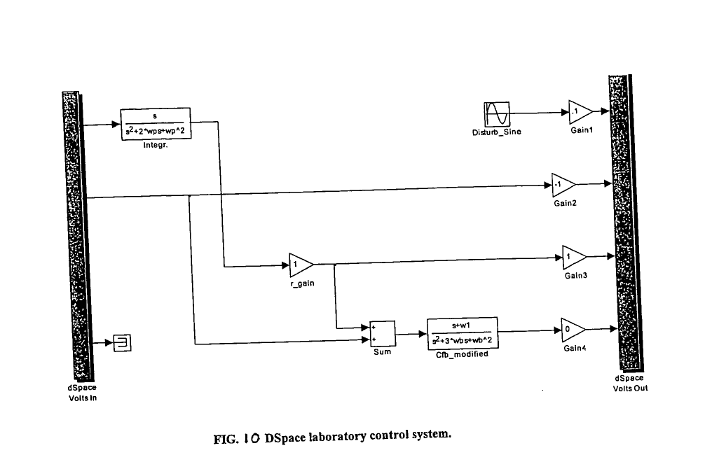

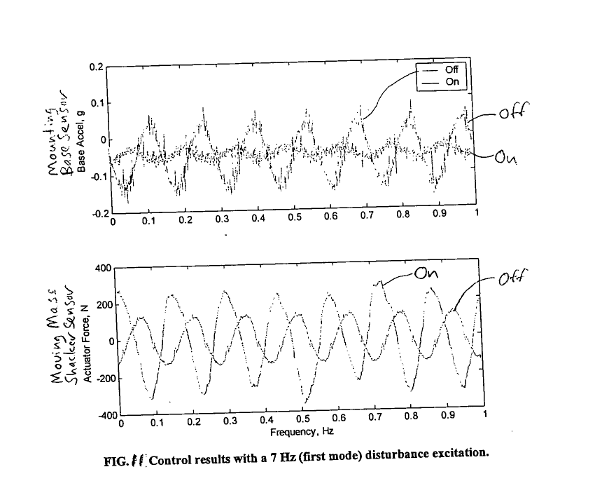

Next, the outer loop was closed. The DSpace control system block diagram is shown in FIG. 10. Inputs 1 and 2 are the base (first sensor 50) and moving mass (second sensor 52) accelerometers, respectively. Ouput 4 is the command to the power amplifier of the controller 36. Motran IFX-470 inertial linear moving mass actuators were used for both the control and disturbance actuators. The gain r_gain represents the inertial damping gain bo. The following parameters were used for this experiment.
Integr.: wp=1 Hz;
Cfb_modified: w1=2.1 Hz, wb=1.5 Hz (form c)
gain4=20, 30; Gain1=0.2 (disturbance amplitude)
r_gain=−10000 (note minus sign)
   The closed loop control results are shown in FIG. 11 and 6.

The invention provides a system and method for active attenuation of low frequency modal responses in the elastic aerostructure bodies of aircrafts, with electromagnetically driven inertial linear moving mass actuator shakers used to incorporate finite bandwidth inertial damping. The invention provides beneficial control of low frequency structural resonances in the aircraft.

It will be apparent to those skilled in the art that various modifications and variations can be made to the invention without departing from the spirit and scope of the invention. Thus, it is intended that the invention cover the modifications and variations of the invention provided they come within the scope of the appended claims and their equivalents.

1. An aircraft, said aircraft comprised of an elastic aerostructure body having an inflight aerodynamically initiated transient lateral modal bending response, said aircraft comprised of at least one first sensor for sensing said inflight aerodynamically initiated transient lateral modal bending response, an electromagnetic moving mass shaker, said electromagnetic moving mass shaker having a moving mass and a mounting base, said electromagnetic moving mass shaker mounted to said elastic aerostructure body, and a controller, wherein said first sensor outputs a sensed lateral modal bending response signal into said controller and said controller electromagnetically drives said electromagnetic moving mass shaker to suppress said lateral modal bending response.

2. An aircraft as claimed in claim 1, said elastic aerostructure body having a front nose, a rear tail, and a midsection between said front nose and said rear tail with said inflight aerodynamically initiated transient lateral modal bending response having a front antinode, said front antinode proximate said front nose, a rear antinode, said rear antinode proximate said rear tail, and a middle node in said body midsection between said front nose and said rear tail.

3. An aircraft as claimed in claim 1, wherein said electromagnetic moving mass shaker has a natural resonant frequency, with said electromagnetic moving mass shaker natural resonant frequency less than 15 Hz.

4. An aircraft as claimed in claim 1, wherein said electromagnetic moving mass shaker has a natural resonant frequency that is proximal to the natural frequency of said transient lateral modal bending response.

5. An aircraft as claimed in claim 1, wherein said aircraft is comprised of at least two wings fixed to said body.

6. An aircraft as claimed in claim 1, wherein said aircraft is comprised of a plurality of rotary wings.

7. A method of making an aircraft with suppressed inflight aerodynamically initiated transient modal bending responses, said method comprising providing an aircraft comprised of an elastic aerostructure body having a inflight aerodynamically initiated transient modal bending response,
providing an aircraft elastic aerostructure body inflight aerodynamically initiated transient modal bending response suppression system, said system comprised of an electromagnetic moving mass shaker, said electromagnetic moving mass shaker having a moving mass and a mounting base, a first sensor and a second sensor, said first sensor fixed proximate said mounting base and said second sensor fixed on said moving mass, and a modal bending response controller,
mounting said electromagnetic moving mass shaker to said aircraft elastic aerostructure body having said inflight aerodynamically initiated transient modal bending response wherein said first sensor and said second sensor output sensor signals into said controller and said controller drives said electromagnetic moving mass to suppress said modal bending response.

8. A method as claimed in claim 7, wherein said elastic aerostructure body has an antinodal front nose, an antinodal rear tail, and a nodal midsection between said antinodal front nose and said antinodal rear tail, said inflight aerodynamically initiated transient lateral modal bending response has a first antinode proximate said antinodal front nose and a second antinode proximate said antinodal rear tail, and said electromagnetic moving mass shaker is mounted proximate said antinodal front nose.

9. A method as claimed in claim 7, wherein said electromagnetic moving mass shaker has a natural resonant frequency, with said electromagnetic moving mass shaker natural resonant frequency less than 15 Hz.

10. A method as claimed in claim 7, wherein said aircraft is comprised of at least two wings fixed to said body.

11. A method as claimed in claim 7, wherein said aircraft is comprised of a plurality of rotary wings.

12. An aircraft elastic aerostructure body inflight aerodynamically initiated transient lateral modal bending response suppression system, said system comprised of an electromagnetic moving mass shaker, said electromagnetic moving mass shaker having a moving mass and a mounting base, said electromagnetic moving mass shaker mounting base for mounting said electromagnetic moving mass shaker to an aircraft elastic aerostructure body having an inflight aerodynamically initiated transient lateral modal bending response, a first sensor and a second sensor, said first sensor fixed proximate said mounting base and said second sensor fixed on said moving mass, a controller, wherein said first sensor and said second sensor output sensor signals into said controller and said controller electromagnetically drives said electromagnetic moving mass at a frequency to suppress said lateral modal bending response.

13. A system as claimed in claim 12, wherein said electromagnetic moving mass shaker has a natural resonant frequency, with said electromagnetic moving mass shaker natural resonant frequency less than 15 Hz.

14. A system as claimed in claim 12, wherein said electromagnetic moving mass shaker has a natural resonant frequency, with said controller driving said electromagnetic moving mass shaker proximate said natural resonant frequency.

15. A method of making an aircraft elastic aerostructure body inflight aerodynamically initiated transient modal bending response suppression system, said method comprising: providing an electromagnetic moving mass shaker, said electromagnetic moving mass shaker having a moving mass and a mounting base, said electromagnetic moving mass shaker mounting base for mounting said electromagnetic moving mass shaker to an aircraft elastic aerostructure body having an inflight aerodynamically initiated transient modal bending response,
providing a first sensor,
providing a second sensor,
fixing said second sensor to said moving mass,
fixing said first sensor proximate said mounting base,
providing a modal bending response controller and connecting said controller with said first sensor, said second sensor, and said electromagnetic moving mass shaker wherein said first sensor and said second sensor output sensor signals into said controller and said controller electromagnetically drives said electromagnetic moving mass to suppress said modal bending response.

16. A method as claimed in claim 15, wherein said electromagnetic moving mass shaker has a natural resonant frequency, with said electromagnetic moving mass shaker natural resonant frequency less than 15 Hz.

17. A method as claimed in claim 15, wherein said electromagnetic moving mass shaker has a natural resonant frequency, with said controller driving said electromagnetic moving mass shaker proximate said natural resonant frequency.

18. A method as claimed in claim 15, wherein said first sensor is comprised of an accelerometer.

19. A method as claimed in claim 15, wherein said second sensor is comprised of an accelerometer.

20. A method as claimed in claim 15, wherein said controller includes an amplifier for producing a driving current.

21. A method as claimed in claim 15, wherein said controller includes a processor.

22. A method of making an aircraft elastic aerostructure body inflight aerodynamically initiated transient lateral modal bending response suppression system, said method comprising: providing a suppression system shaker, said suppression system shaker having a moving mass and a mounting base, said suppression system shaker mounting base for mounting said suppression system shaker to an aircraft elastic aerostructure body having an inflight aerodynamically initiated transient lateral modal bending response,
providing a first suppression system sensor,
providing a second suppression system sensor for sensing said moving mass,
fixing said second suppression system sensor proximate said moving mass,
fixing said first suppression system sensor proximate said mounting base,
providing a modal bending response suppression system controller and connecting said suppression system controller with said first suppression system sensor, said second suppression system sensor, and said suppression system shaker wherein said first suppression system sensor and said second suppression system sensor output sensor signals into said suppression system controller and said suppression system controller drives said suppression system moving mass to suppress said lateral modal bending response.
